(19) United States
(12) Patent Application Publication
(10) Pub. No.: US 2009/0327135 A1
(43) Pub. Date: Dec. 31, 2009

(54) CREDIT CARD PAIRED WITH LOCATION IDENTIFIABLE DEVICE FOR POINT OF SERVICE FRAUD DETECTION

(76) Inventors: Loc Duc Nguyen, Berkeley, CA (US); Chris S. Nelson, Foster City, CA (US); Charles Quach, Pacifica, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/492,345

(22) Filed: Jun. 26, 2009

Related U.S. Application Data
(60) Provisional application No. 61/076,101, filed on Jun. 26, 2008.

(51) Int. Cl. G06Q 40/00

(52) U.S. Cl. 705/44

(57) ABSTRACT

A method and apparatus for identifying attempted fraud using a consumer account in real time, the method comprising the steps of determining when a consumer account is used to attempt to obtain a resource from a resource provider, determining whether a consumer apparatus that is associated with the consumer account is located at a location associated with the resource provider and indicating that the resource provider should provide the resource when the consumer apparatus is at a location associated with the resource provider.

### CROSS-REFERENCE TO RELATED APPLICATIONS

The present application claims the benefit of priority under 35 U.S.C. §119 from U.S. Provisional Application No. 61/076,101 entitled “Credit Card Paired with Location Identifiable Device for Point of Service Fraud Detection,” filed on Jun. 26, 2008, the disclosure of which is hereby incorporated by reference in its entirety for all purposes.

### FIELD

The present invention relates to financial transaction authorization and more specifically to systems and methods that enable payment authorization based on the location of a consumer apparatus that is associated with a financial account.

### BACKGROUND

Credit card fraud is a wide-ranging term for theft or fraud committed using a credit card or any similar payment mechanism as a fraudulent source of funds in a transaction. The purpose may be to obtain goods without paying or to obtain unauthorized funds from an account.

Credit card fraud begins with either the theft of a physical credit card or the compromise of data associated with a credit card account, including a card account number, expiration date, security code, or other information that would routinely and necessarily be available to a merchant during a legitimate transaction. The compromise can occur by many common routes and can usually be conducted without tipping off a card holder, a merchant or a card issuing bank, at least until the account is ultimately used for fraud. The rapid growth of credit card use on the Internet has made database security lapses particularly costly—in some cases, millions of accounts have been compromised.

Stolen cards, when recognized as missing, can be reported quickly by card holders, but a compromised account can be hoarded by a thief for weeks or months before any fraudulent use, making it difficult to identify the source of the compromise. The card holder may not discover fraudulent use until receiving a billing statement, which may be delivered infrequently.

When account information is stolen, the account associated therewith remains usable until the account holder notifies the bank that the account has been compromised. Most banks have toll-free telephone numbers with 24-hour support to encourage prompt reporting of compromised accounts. Nevertheless, it is possible for a thief to make unauthorized purchases using a compromised account up until the account is cancelled. In the absence of other security measures, a thief could potentially purchase thousands of dollars in merchandise or services before an account holder or a bank realizes that account information is in the wrong hands. While account holder liability for fraudulent purchases is limited by law in the United States and other countries, account card issuing banks loose billions of dollars each year to fraudulent account transactions.

Solutions have been developed for limiting or reducing credit card fraud but existing solutions have not been very successful. For instance, the most common solution has been to require a card holder's signature on the back surface of a card that can be compared by a merchant's employee to a card user's signature during a transaction. Another solution has been to place a card holder's picture on the front or back of a card that can be compared by a merchant's employee to a card user's appearance during a transaction. While signature and appearance matching would appear to be good deterrents to credit card fraud, in reality they have not been very successful either because merchant employees are incapable of making sound comparisons or because the employees do not take their responsibility seriously. In addition, signature and appearance matching techniques do not work well for verifying on-line transactions.

### SUMMARY

It has been recognized that one way to substantially eliminate at least some types of credit account fraud is to take advantage of capabilities of location enabled personal electronic devices that are becoming ubiquitous in many countries including the United States. To this end, each year a greater percentage of personal electronic devices (e.g., cellular telephones) manufactured and sold are being equipped with global positioning system (GPS) capabilities so that the locations of the devices can be determined within a few feet of their actual positions. It is believed that within the next few years virtually all cellular telephones sold will be GPS enabled and that a large percentage of people that have credit cards will also have a GPS enabled wireless telephone.

When a person carries a GPS enabled device, the location of the person carrying the device can be quickly identified via a GPS system including, for instance, satellites and mobile network towers that are linked to a mobile network operator server. According to at least some embodiments of the present invention, a credit card holder that has a portable (i.e., hand held, wearable, etc.) GPS enabled device may sign up for a service whereby the card holder logically associates her GPS enabled device with her credit card account number and commits to use the card only when carrying the GPS enabled device with its GPS function activated. Then, whenever, the holder uses the credit card to purchase a product or service at a merchant's place of business (i.e., at a point of service (POS)), an authorization entity may determine the location of the GPS enabled device and whether or not the GPS enabled device is within a zone, range or distance of the merchant where the transaction is underway. Here, where the GPS enabled device is not located proximate the merchant (i.e., is not within a zone or distance from a location associated with the merchant), the authorization entity may indicate to the merchant that the card use is fraudulent and should be stopped.

Some embodiments of the invention include a method for identifying attempted fraud using a consumer account in real time, the method comprising the steps of determining when a consumer account is used to attempt to obtain a resource from a resource provider, determining whether a consumer apparatus that is associated with the consumer account is located at a location associated with the resource provider and indicating that the resource provider should provide the resource when the consumer apparatus is at a location associated with the resource provider.

In some cases the step of determining when the consumer account is used to attempt to obtain a resource includes receiving a first transmission from a resource provider that includes the consumer account number used to attempt to obtain a resource from the resource provider and provider information usable to identify the provider. In some cases the step of determining when the consumer apparatus is located at a location associated with the resource provider includes using the provider information to identify the location associated with the resource provider.

In some cases the provider information includes a provider identifier, the method further includes the step of correlating provider identifiers and provider locations within a provider database, the step of using the provider information to identify the location associated with a resource provider including accessing the provider database and identifying a provider location that is associated with a provider identifier. In some cases the consumer account is provided on a credit card and the resource attempted to be obtained is credit. In some cases the consumer apparatus is one of a wireless portable telephone, a key fob, a portable computer, a wearable article of clothing and a wearable article of jewelry. In some cases the consumer apparatus is a GPS enabled mobile phone.

In some cases the step of determining whether the identified consumer apparatus is at a location includes the steps of receiving a transmission of location information associated with the consumer apparatus, using the location information to identify the location of the consumer apparatus and comparing the location of the consumer apparatus to the location associated with the resource provider.

In some cases the method further includes the step of, when the identified consumer apparatus is at a location other than the location associated with the resource provider when the consumer account is used, transmitting a signal to the resource provider indicating that the resource provider should deny provision of the resource.

In some embodiments the consumer apparatus is a mobile wireless phone, the method further includes the step of, when the identified consumer apparatus is at a location other than the location associated with the resource provider when the consumer account is used, transmitting a message addressed to the mobile wireless phone indicating that an attempt has been made to use the consumer device. In some cases the step of transmitting a message addressed to the mobile wireless phone includes transmitting an indication of the resource provider from which the resource has been sought and an indication of the resource sought. Some embodiments further include the steps of, after transmitting the message to the mobile wireless phone indicating that an attempt has been made to use the consumer account, receiving an authorization transmission originated at the mobile wireless phone authorizing the attempted use.

Some cases further include the step of, when an authorizing transmission that originated at the mobile wireless phone is received, transmitting a signal to the resource provider indicating that the source should be provided.

Some embodiments include a method for identifying attempted fraud using a consumer account in real time, the method comprising the steps of, when a financial account number is used to attempt to purchase a resource at a merchant location, determining whether a location enabled consumer apparatus correlated with the financial account number used is proximate the merchant location and when the location enabled consumer apparatus is proximate the merchant location, authorizing purchase of the resource. In some cases the location enabled consumer apparatuses are GPS enabled wireless devices. In some embodiments each of the wireless devices includes a mobile phone.

Some embodiments include a method for identifying attempted fraud using a financial card in real time, the method comprising the steps of providing a consumer database that correlates financial account numbers with GPS enabled wireless consumer apparatuses, providing a merchant database that correlates merchant identifiers with merchant locations, providing a first financial account number and a first GPS enabled wireless consumer apparatus to a first consumer, receiving the first financial account number at a first merchant during an attempt to obtain a resource from the merchant, providing the first financial account number and a first merchant identifier to an authorization entity, at the authorization entity, using the consumer database to identify a consumer apparatus associated with the first financial account number, requesting location information regarding the location of the identified consumer apparatus, receiving location information regarding the location of the identified consumer apparatus, using the merchant database to identify the location of the first merchant, comparing the locations of the identified consumer apparatus and the first merchant and based on the comparison, determining whether to authorize provision of the resource.

In some cases the step of requesting location information includes transmitting a location request to a mobile network operator (MNO), the step of receiving location information including the MNO and the consumer apparatus cooperating to identify the consumer apparatus location and the MNO transmitting the consumer apparatus location to the authorization agent. Some embodiments further include the step of, when authorization is to be provided, transmitting an authorization signal to the first merchant. Some embodiments further include the step of, when authorization is to be foregone, transmitting a rejection signal to the first merchant. Some embodiments further include the step of, when authorization is to be foregone, transmitting a notice to the first consumer apparatus.

Still other embodiments include an apparatus for identifying attempted fraud using a consumer account in real time, the apparatus comprising a computer running a program to perform a process including the steps of, determining when the consumer account is used to attempt to obtain a resource from a resource provider, determining whether a consumer apparatus that is associated with the consumer account is located at a location associated with the resource provider and indicating that the resource provider should provide the resource when the consumer apparatus is at a location associated with the resource provider.

In some cases the computer determines when the consumer account is used to attempt to obtain a resource by receiving a first transmission from a resource provider that includes the consumer account number used to attempt to obtain a resource from the resource provider and provider information usable to identify the provider. In some cases the computer determines when the consumer apparatus is located at a location associated with the resource provider by using the provider information to identify the location associated with the resource provider. In some cases the provider information includes a provider identifier, the apparatus further including a provider database that correlates provider identifiers and provider locations, and the computer uses the provider information to identify the location associated with a resource provider by accessing the provider database and identifying a provider location that is associated with a provider identifier.

In some embodiments the consumer account is provided on a credit card and the resource attempted to be obtained is credit. In some cases the consumer apparatus is one of a wireless portable telephone, a key fob, a portable computer, a wearable article of clothing and a wearable article of jewelry. In some cases the consumer apparatus is a GPS enabled mobile phone. In some cases the computer determines whether the identified consumer apparatus is at a location by receiving a transmission of location information associated with the consumer apparatus, using the location information to identify the location of the consumer apparatus and comparing the location of the consumer apparatus to the location of the resource provider.

In some embodiments the computer further runs a program to, when the identified consumer apparatus is at a location other than the location associated with the resource provider when the consumer account is used, transmit a signal to the resource provider indicating that the resource provider should deny provision of the resource. In some cases the consumer apparatus is a mobile wireless phone, the computer further programmed to, when the identified consumer apparatus is at a location other than the location associated with the resource provider when the consumer account is used, transmit a message addressed to the mobile wireless phone indicating that an attempt has been made to use the consumer device. In some cases, when the computer transmits a message addressed to the mobile wireless phone, the computer includes an indication of the resource provider from which the resource has been sought and an indication of the resource sought.

In some cases the computer further, after transmitting the message to the mobile wireless phone indicating that an attempt has been made to used the consumer account, receives an authorization transmission originated at the mobile wireless phone authorizing the attempted use. In some cases the computer further, when an authorizing transmission that originated at the mobile wireless phone is received, transmits a signal to the resource provider indicating that the source should be provided.

Yet other embodiments include an apparatus for identifying attempted fraud using a financial account number in real time, the apparatus comprising a computer running a program to perform the steps of, when a financial account number is used to attempt to purchase a resource at a merchant location, determine whether a location enabled consumer apparatus correlated with the financial account number used is proximate the merchant location and when the location enabled consumer apparatus is proximate the merchant location, authorize purchase of the resource.

Some embodiments include an apparatus for identifying attempted fraud using a consumer account in real time, the apparatus comprising means for associating a consumer account with a consumer apparatus in a consumer database, means for determining when the consumer account is used to attempt to obtain a resource from a resource provider, means for determining whether the consumer apparatus that is associated with the consumer account is located within at a location associated with the resource provider and means for indicating that the resource provider should provide the resource when the consumer apparatus is at a location associated with the resource provider.

In some cases the means for determining when the consumer account is used to attempt to obtain a resource includes means for receiving a first transmission from a resource provider that includes the consumer account number used to attempt to obtain a resource from the resource provider and provider information usable to identify the provider.

In some cases the means for determining when the consumer apparatus is located at a location associated with the resource provider includes means for using the provider information to identify the location associated with the provider. Some cases further include means for, when the identified consumer apparatus is at a location other than the location associated with the resource provider when the consumer account is used, transmitting a signal to the resource provider indicating that the resource provider should deny provision of the resource.

In some cases the consumer apparatus is a portable wireless telephone, the apparatus further including means for, when the identified consumer apparatus is at a location other than the location associated with the resource provider when the consumer account is used, transmitting a message addressed to the wireless telephone indicating that an attempt has been made to use the consumer device.

Other embodiments include an apparatus for identifying attempted fraud using an account number in real time, the apparatus comprising means for correlating financial account numbers with location enabled consumer apparatuses, means for, when a financial account number is used to attempt to purchase a resource at a merchant location, determining whether the location enabled consumer apparatus correlated with the financial account number used is proximate the merchant location and means for, when the location enabled consumer apparatus is proximate the merchant location, authorizing purchase of the resource.

Some embodiments include a method for identifying attempted fraud using a consumer account in real time, the method comprising the steps of associating a consumer account with a consumer apparatus in a consumer database, determining when a consumer account is used to attempt to purchase a resource from a resource provider, when the consumer account is used to attempt to purchase, transmitting a request communication to a consumer apparatus requesting authorization from the consumer associated with the consumer apparatus to allow the purchase, receiving a request response communication from the consumer apparatus including a response to the request and when the request response includes an authorization, transmitting an authorization to the resource provider authorizing the purchase and when the request response denies authorization, transmitting a denial of the purchase to the resource provider.

Some cases include a method for identifying attempted fraud using a consumer transaction device in real time, the method comprising the steps of determining when a consumer transaction device is used to attempt to purchase a resource from a resource provider, determining whether a consumer apparatus that is associated with the consumer transaction device is located proximate the consumer transaction device and indicating that the resource provider should provide the resource when the consumer apparatus is located proximate the consumer transaction device.

Yet other embodiments include a method for identifying attempted fraud using a consumer account in real time, the method comprising the steps of determining when a consumer account is used to attempt to obtain a resource from a resource provider, determining whether a consumer apparatus that is associated with the consumer account is located at a home location associated with the consumer account and indicating that the resource provider should provide the resource when the consumer apparatus is at the home location.

Some cases further include the steps of determining whether the consumer apparatus is located at a location associated with the resource provider and indicating that the resource provider should provide the resource when the consumer apparatus is at a location associated with the resource provider, when the consumer apparatus is at a location other than the home location and the location associated with the resource provider, indicating that the resource provider should reject the attempt to obtain the resource.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention can be employed. Other aspects, advantages and novel features of the invention will become apparent from the following detailed description of the invention when considered in conjunction with the drawings.

### BRIEF DESCRIPTION OF THE DRAWINGS

FIG. 1 is a schematic diagram illustrating a system including an authorizing agent in which the methods and apparatus of the present invention may be used;

FIG. 2 is a schematic diagram illustrating an exemplary consumer database that may be used by the authorization entity shown in FIG. 1;

FIG. 3 is a schematic diagram illustrating a resource provider database that may be used by the authorization entity of FIG. 1;

FIG. 4 is a schematic illustrating a location or zone associated with a merchant;

FIG. 5 is similar to FIG. 4, albeit illustrating a different zone or location associated with a merchant;

FIG. 6 is a flow chart illustrating a method for determining the location of a mobile phone associated with a credit account when the account is used to facilitate a transaction that is consistent with at least some embodiments of the present invention;

FIG. 7 is a flow chart illustrating a sub-process that may be substituted for a portion of the process shown in FIG. 6 whereby a rejected transaction is reported to a consumer;

FIG. 8 is a flow chart illustrating a sub-process that may be substituted for a portion of the process shown in FIG. 6 whereby a rejected transaction is reported to a consumer along with a request for authorization;

FIG. 9 is a sub-process that may be substituted for a portion of the process shown in FIG. 6 whereby a consumer registers for an inventive service;

FIG. 10 is a flow chart illustrating a sub-process that may be substituted for a portion of the sub-process shown in FIG. 9 whereby a more sophisticated registration occurs;

FIG. 11 is a flow chart illustrating a sub-process that may be substituted for a portion of the process shown in FIG. 6;

FIG. 12 is a flow chart illustrating a sub-process that may be substituted for a portion of the process shown in FIG. 6;

FIG. 13 is a schematic showing a consumer, a consumer apparatus and a consumer transaction device in the form of a phone; and

FIG. 14 is a flow chart illustrating a method that may be performed using the apparatus and device shown in FIG. 13 whereby completion of a transaction is tied to proximity of a consumer transaction device to a consumer apparatus.

### DESCRIPTION

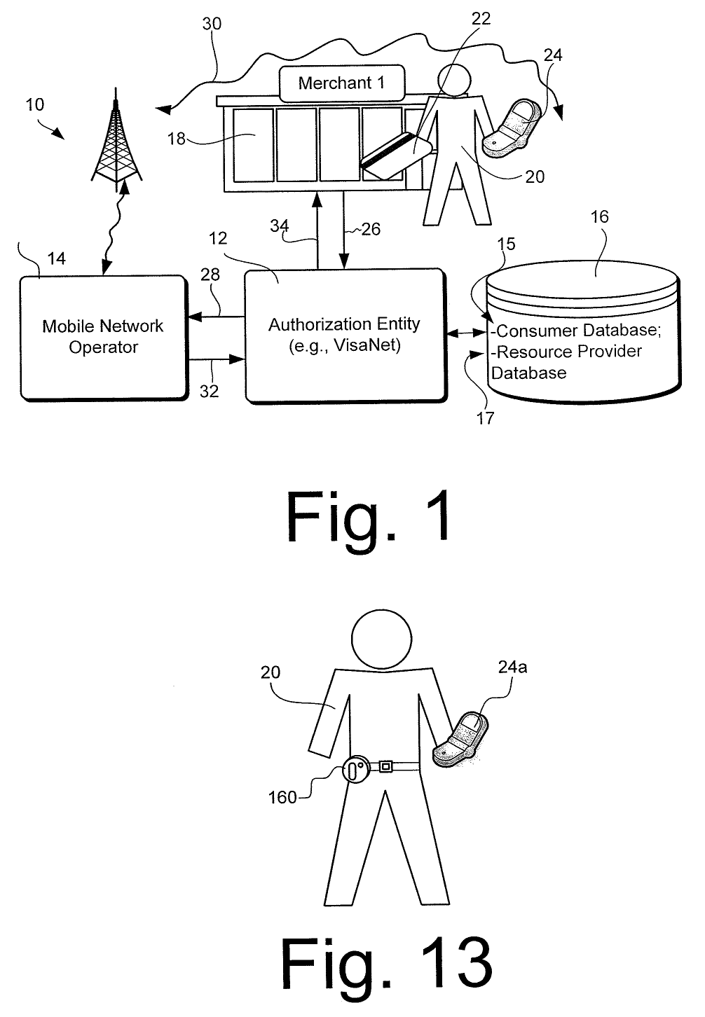

Referring now to the drawings wherein like reference numerals correspond to similar elements throughout the several views and, more specifically, referring to FIG. 1, the present invention will be described in the context of an exemplary system 10 in which a consumer 20 attempts to purchase a resource from a resource provider where the system 10 includes one or more mobile network operators 14, an authorization entity 12 and at least one database 16. Although not illustrated, the system 10 also includes one more point of service (POS) devices at each merchant location for obtaining account information from consumers when purchases are to be performed. Here, the resource may be any type of product or service and the resource provider may be a merchant 18 or any other type of product or service provider. In the interest of simplifying this explanation, it will be assumed that the resource provider is a merchant selling a product. Consumer 20 uses a credit card 22 and also employs a personal consumer apparatus 24. The consumer apparatus 24 may take any of several different forms including but not limited to, for example, a mobile cellular telephone, a key fob on a key ring, a portable computer such as a personal digital assistant (PDA), a wearable article of clothing such as a belt buckle or a wearable article of jewelry such as a ring, a button, a pin, etc. In the interest of simplifying this explanation, unless indicated otherwise, it will be assumed that the consumer apparatus 24 is a mobile wireless telephone. The mobile wireless telephone 24 (or other consumer apparatus), in at least some embodiments of the present invention, is location enabled meaning that the phone 24 can determine its location at any time when turned on. For example, in at least some embodiments, phone 24 will be global positioning system (GPS) enabled such that the phone 24 can use signals generated by satellites or the like to identify a location estimate within a few feet of its actual location.

In other embodiments phone 24 may be able to receive signals from local beacons that are then used to identify location. For instance, each merchant 18 within a shopping mall may be equipped with a localized beacon signal generator (not illustrated) that generates a wireless beacon signal that can be sensed by phone 24 when the phone is proximate a checkout counter where the beacon signal indicates merchant location, merchant identity, etc. Herein, the phrases location enabled, position enabled, GPS enabled, etc., should be construed as having similar meanings unless indicated otherwise.

Authorization entity 12 may be any entity that authorizes credit card purchases for merchants or other resource providers. For example VISA and MasterCard are exemplary authorizing entities. The authorization entity 12 is linked via a computer network (e.g., the Internet, a private network, etc.) to each of the merchant POS device so that the entity 12 and merchants 18 have two-way communication. As implied by the label, the authorization entity 12 receives information from the merchant 18 associated with an attempted purchase by a consumer 20, verifies that a consumer account used to attempt a purchase is valid and that the amount of that purchase is acceptable and then authorizes the purchase. Where an account is invalid or the line of credit associated with an account is insufficient to cover a purchase, authorization is denied.

Referring still to FIG. 1, mobile network operator (MNO) 14 provides mobile computing and communication services such as cellular phone services, paging services, data transmission services, and so on. In at least some embodiment of the present invention authorization entity 12 is linked to the mobile network operator 14 for two-way communication. The network operator 14 can communicate wirelessly (see 30) with mobile phone 24 to provide information thereto and received information therefrom.

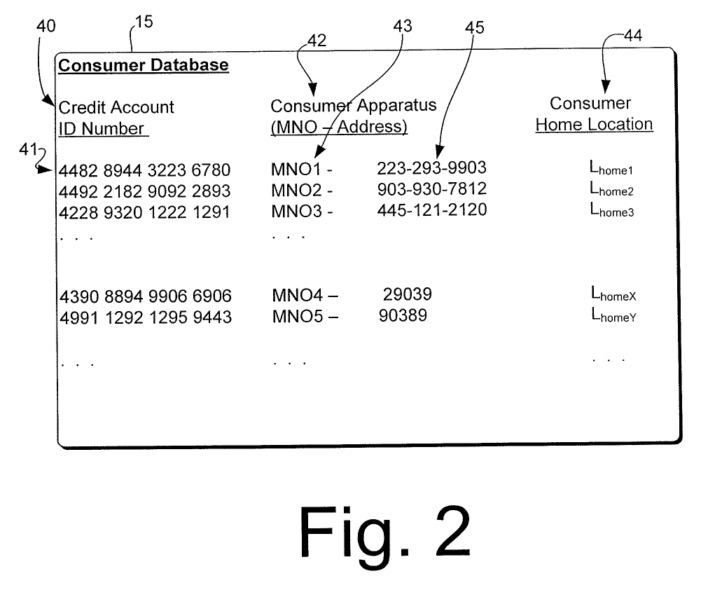

Referring still to FIG. 1, database 16 includes two sub-databases including a consumer database 15 and a resource provider database 17. Referring also to FIG. 2, consumer database 15 includes credit card/account ID numbers correlated with consumer apparatus. To this end, exemplary database 15 includes a credit account ID number column 40 a consumer apparatus column 42. The credit ID number column 40, as the label implies, lists all credit account ID numbers that are assigned to consumers 20 (see again FIG. 1). Consumer apparatus column 42 lists a separate consumer apparatus for each of the credit card ID numbers in column 40. In column 42, the customer apparatus is identified by the mobile network operator that supports the apparatus and an apparatus address. Where the customer apparatus is a mobile phone, the apparatus address is the telephone number associated with the phone. Where the apparatus type is other than a phone, the apparatus address may be some other identifying number or identifier. Thus, for example, the first credit card ID number 41 in column 40 is associated with a mobile phone having phone number 45 and is supported by a first mobile network operator 43. Other ID numbers in column 40 are associated with other network operators and mobile phone numbers.

Although not illustrated, it is contemplated that two or more credit account numbers in column 40 could be associated with a single consumer apparatus in column 42. Similarly, in some cases a single account number in column 40 may be associated with two or more consumer apparatus in column 42 (e.g., where a consumer has both a work mobile phone and a personal mobile phone).

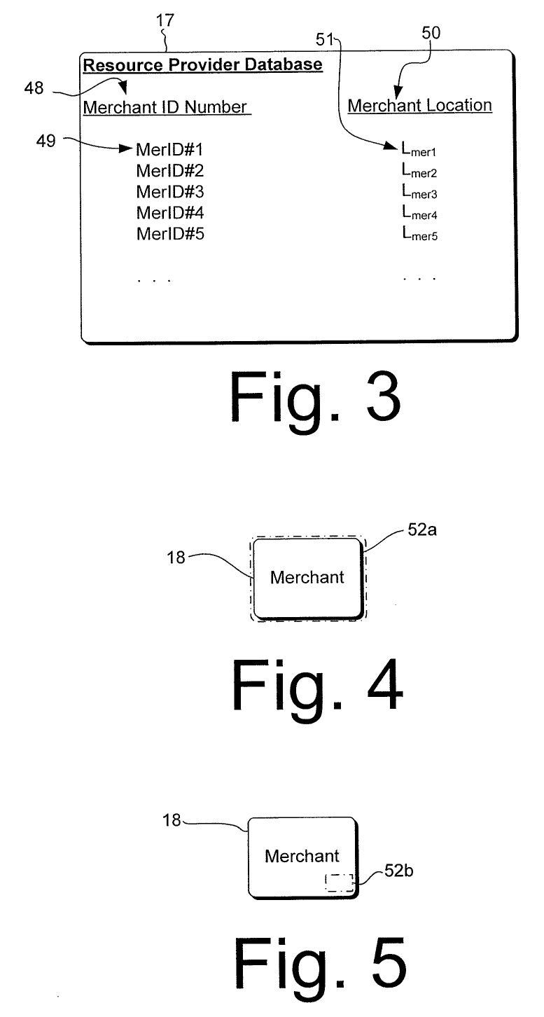

Referring now to FIG. 3, an exemplary resource provider database 17 is illustrated that correlates merchants that use system 10 in FIG. 1 with merchant locations. To this end, database 17 includes a merchant ID number column 48 and a merchant location column 50. The merchant ID number column 48 lists all of the merchants that use system 10. Location column 50 lists a separate location for each one of the merchants in column 48. Thus, for example, for a first merchant 49 in column 48, the location 51 in column 50 is identified by label Lₘₑᵣ₁. The merchant locations will generally correspond to a zone or space that is associated with the merchant and in which purchases of products or services from the merchant will likely occur. For example, referring to FIG. 4, where a merchant 18 operates a 5000 square foot store, in at least some embodiments, the merchant location will correspond to a zone 52a that includes essentially the entire merchant store space. In other embodiments, where a merchant operates a 5000 square foot store but there is only one location (e.g., at an entry to the store) at which purchases can be made, the merchant location may be limited to a relatively small space 52b proximate the check-out location. Locations can be specified in column 50 of FIG. 3 in any manner including, for instance, longitudinal and latitudinal coordinates that define a zone, a single longitudinal and latitudinal location along with a threshold distance from that location, etc.

Although each of exemplary databases 15 and 17 are shown in table form, it should be appreciated that the databases can and likely would take on more sophisticated configurations and the invention should not be limited to table type formats.

Referring once again to FIG. 1, according to at least some inventive embodiments, when a consumer 20 provides a consumer credit account number to a merchant 18 to facilitate a purchase, the merchant 18 POS device receives the account number and perhaps other information, transmits a communication 26 to the authorizing entity 12 that includes the consumer credit account number and resource provider information usable to identify the merchant. When the authorization entity 12 receives the communication, then entity 12 performs several processes. First, the authorization entity 12 access the consumer database 15 (see again FIG. 2) and uses the credit account ID number in the communication from the merchant to identify the consumer apparatus associated or correlated therewith. In the present example, authorization entity 12 identifies a mobile wireless phone in column 42 that is associated with the credit card ID number received in the communication. Next, the authorization entity 12 transmits a request 28 to the mobile network operator (MNO) that supports the consumer apparatus as indicated in column 42 to request the location of the mobile wireless telephone. The operator 14 transmits a request 30 to mobile phone 24 causing the phone 24 to transmit a return message to the operator 14 indicating the location of the mobile phone 24. Operator 14 returns 32 the phone location to the authorization entity 12.

Referring still to FIG. 1 and also to FIG. 3, in addition, the authorization entity 12 accesses resource provider database 17 and uses the merchant identifying information from the communication 26 to identify the location associated with the merchant in column 50. Next, authorization entity 12 compares the merchant location to the location of the mobile wireless phone 24. Where the mobile wireless phone 24 is at the merchant location (i.e., within a zone associated with the merchant), if other requirements (e.g., a valid account, a credit limit that exceeds the purchase price, etc.) for purchase authorization are met, authorization entity 12 transmits a communication 34 back to merchant 18 authorizing the purchase. If, however, the mobile phone 24 location is other than the location of the merchant, authorization entity 12 transmits a communication 34 back to merchant 18 indicating that the purchase should be denied.

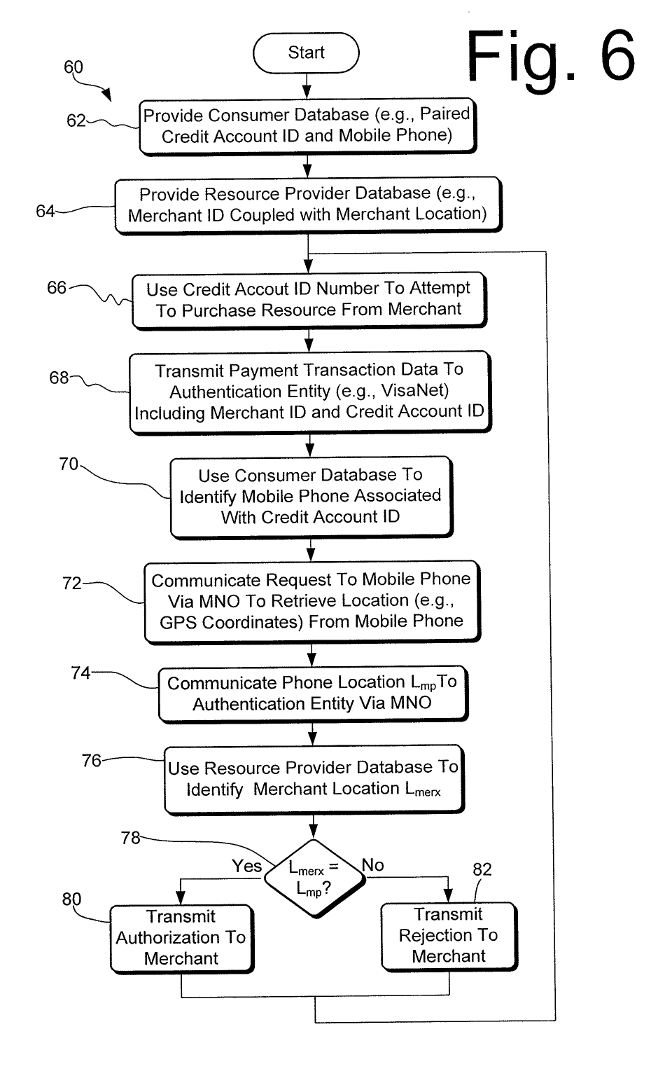

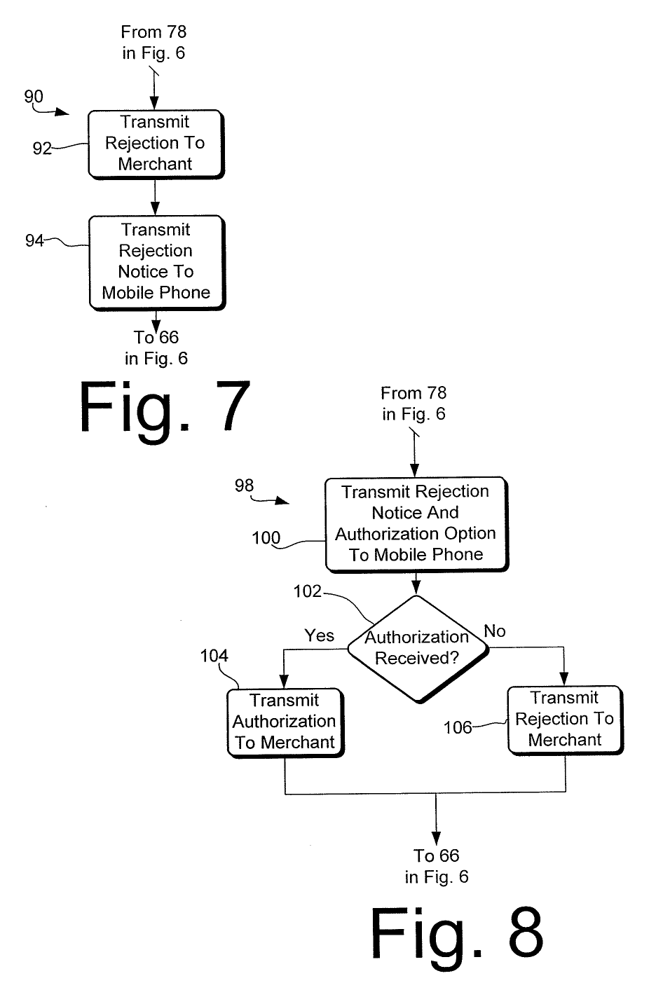

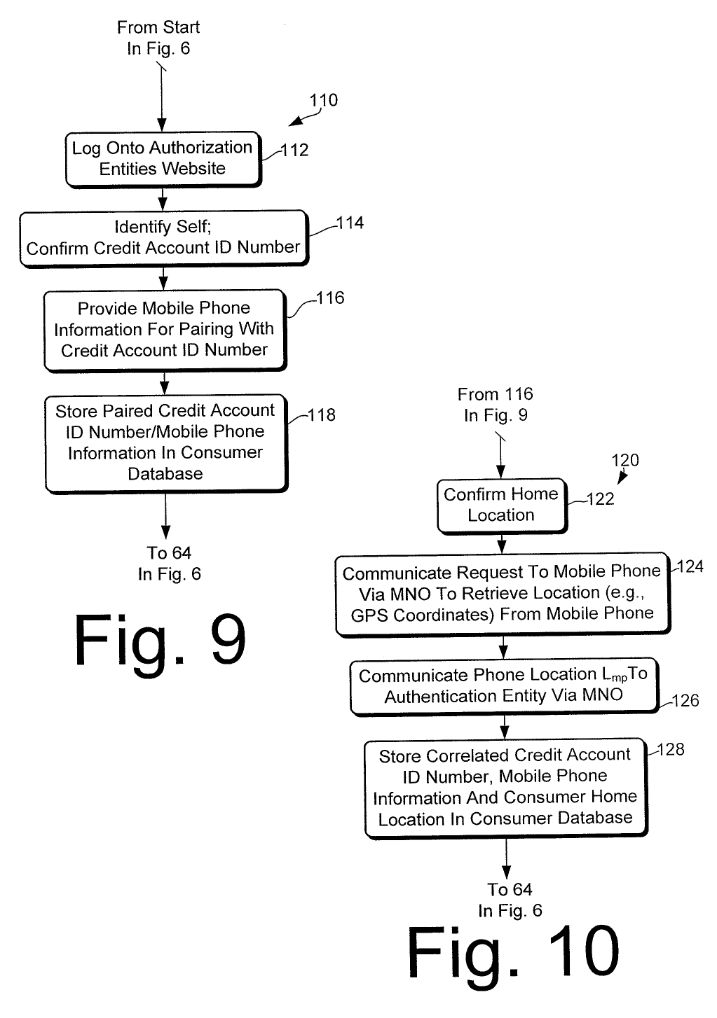

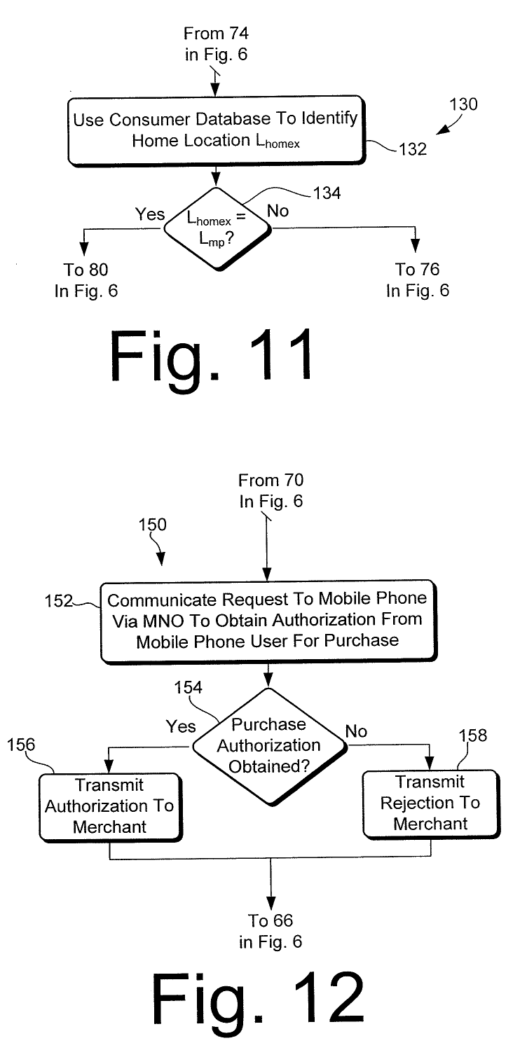

Referring now to FIG. 6, the exemplary method briefly described above is shown in flow chart form. Referring also to FIGS. 1, 2 and 3, at block 62, the consumer database 15 is provided which correlates credit account ID numbers and mobile phones (i.e., consumer apparatus) together. At block 64, the resource provider database 17 (see FIG. 3) is provided which correlates merchant identifications with merchant locations.

Continuing, at block 66, a consumer 20 uses a credit account ID number to attempt to purchase a resource from the merchant 18. Here, the credit account ID number may be obtained by the merchant directly from a credit card 22 or may be verbally provided by the consumer 20. At block 68, merchant 18 transmits payment transaction data to authorization entity 12 including merchant identifying information and the credit account ID number. At block 70, authorization entity 12 uses consumer database 15 to identify the mobile phone 24 associated with the credit account ID number received in the communication 26. At block 72, authorization entity 12 transmits a communication to mobile phone 24 via mobile network operator 14 requesting location information from the mobile phone. At block 74 phone 24 transmits the mobile phone location Lₘₚ to authorization entity 12 via network operator 14.

At block 76, authorization entity 12 uses the resource provider database 17 to identify the location Lₘₑᵣₓ of the merchant identified in communication 26 from merchant 18. At block 78 authorization entity 12 compares the merchant location Lₘₑᵣₓ to the mobile phone location Lₘₚ. Where the mobile phone location Lₘₚ is equal to the merchant location Lₘₑᵣₓ, control passes to block 80 where authorization entity 12 transmits an authorization communication 34 to merchant 18 authorizing the purchase. At block 78, where the mobile phone location Lₘₚ is other than the merchant location Lₘₑᵣₓ, control passes to block 82 where authorization entity 12 transmits a communication 34 rejecting the purchase. The merchant 18 allows or rejects the purchase accordingly.

In at least some embodiments, when a purchase is rejected because a mobile phone is not located at a location associated with a merchant, in addition to transmitting a communication to reject the purchase, the authorization entity 12 may transmit a rejection notice to the consumer associated with the credit card that was used to attempt to make a purchase. For instance, where a purchase is rejected, authorization entity 12 may transmit a rejection notice via network operator 14 to mobile phone 24 associated with the card holding consumer 20. When the consumer receives the rejection notice, the consumer independently determines if the cardholder's account has been nefariously used. To this end, referring to FIG. 7, a sub-process 90 that may be substituted for a portion of the process shown in FIG. 6 is illustrated. At block 78, where the mobile phone location Lₘₚ is other than the location Lₘₑᵣₓ associated with the merchant, control may pass to block 92 in FIG. 7 where the rejection communication is transmitted to the merchant. After block 92, control can then pass to block 94 where a rejection notice is transmitted to the card holder (e.g., to the card holder's phone 24). After block 94, control passes back to block 66 in FIG. 6 where the process as illustrated is repeated.

In at least some embodiments it is contemplated that, when a mobile phone location Lₘₚ is different than the location of a merchant Lₘₑᵣₓ from which a purchase is sought, a consumer may be given the option to still authorize a purchase. For example, where a parent allows a child to use her credit card to make a specific purchase, the parent may retain the mobile phone 24 that is paired with the credit card and allow the child to take the credit card and attempt to make a purchase. When a child attempts to make a purchase, authorization entity 12 may recognize that the mobile phone 14 is not at the location associated with the merchant at which the purchase is attempted and may transmit a message to the mobile phone 24 requesting authorization of the purchase. Here, where the purchase is consistent with the parent's intended use of the credit card, the parent can authorize the purchase. However, where the purchase is inconsistent with the parent's intention, the parent may reject the purchase using the credit card. This consumer request for authorization feature is also useful when a parent wants a child to have her own credit account but the parent wants to monitor the child's use of the account. Here, the parent could associate the child's account (or more than one child's account) with the parent's phone and receive notice and a request for authorization each time a child attempts to purchase a product or service using the account. Once the child develops good money management skills, the parent could associate the account with the child's mobile phone.

The authorization request sent to the mobile phone may include details on the transaction, the merchant, the merchant location, or other relevant information. This information can be used by the parent to help decide whether or not to authorize the transaction. Other features could also be implemented along with the authorization feature. For example, a parent may pre-authorize transaction under a certain value or pre-authorize transactions at certain merchants or certain classes of merchants. Alternatively, a parent could pre-authorize transactions that occur near specific locations. For example, a parent may pre-authorize transactions that occur within 1 mile of a child's school. As described later in this disclosure, a location for a school can be recorded in a similar manner as a home location. Other variables may also be taken into account. For example, a parent may pre-authorize transactions occurring between 11:45 AM and 1:15 PM because that is when the child typically purchases lunch. These variations can be further combined in any number of different permutations.

Referring now to FIG. 8, a sub-process 98 that is consistent with a case where a mobile phone user can authorize a purchase even when a mobile phone is not located at a merchant's location that may be substituted for a portion of the process as shown in FIG. 6 is illustrated. Referring also to FIG. 6, at block 78 when the mobile phone location Lₘₚ is other than the location Lₘₑᵣₓ associated with the merchant, control may pass to block 100 in FIG. 8 where authorization entity 12 transmits a rejection notice and authorization option to the consumer's mobile phone 24 via network operator 14. At block 102, authorization entity 12 receives a communication back from mobile phone 24 via operator 14 and determines whether or not the authorization for the purchase has been received. Where authorization has been received, entity 12 transmits a communication authorizing the purchase to the merchant at block 104. Where authorization is denied at block 102, at block 106 authorization entity 12 transmits a rejection communication to merchant 18. After blocks 104 and 106, control passes back up to block 66 in FIG. 6. The system may include a timeout feature whereby, if an authorization is sought from a consumer and is not received within a timeout period (e.g., 20 seconds), a transmission is sent to the merchant denying the transaction.

Referring once again to FIG. 6, the process of providing a consumer database that pairs credit card ID number and mobile phones may require consumers 20 to initiate the pairing process. To this end, a sub-process 110 that may be substituted for block 62 in FIG. 6 is illustrated in FIG. 9. At block 112, a consumer uses a personal computer or the like to log on to a web site associated with authorization entity 12. At block 114, the consumer identifies herself and confirms her credit account ID number. At block 116, the consumer provides mobile phone information for pairing with a credit card ID number. Here, consistent with the consumer database shown in FIG. 15, the mobile phone information would include some indication of a mobile network operator that supports the consumer's mobile phone along with the phone number corresponding to the consumer's mobile phone. At block 118, authorization entity 12 stores the paired credit account ID number and mobile phone information in the consumer database 15.

While credit cards and credit card account numbers are often used to make purchases at merchant locations, it has also been recognized that many purchases of services and products are now made remotely using the Internet or the like. Thus, for example, many consumers use personal computers at home or at work to purchase goods or services from merchants around the world. In at least some embodiments it is contemplated that consumers will be able to identify one or more “home locations” that correspond to locations of computing devices such as personal computers that are routinely used to consummate on-line purchases. Once a home location is identified, in at least some embodiments, the authorization entity 12 will be programmed to allow remote purchases from the home locations and will be able to verify that the purchases are being made at the home locations using consumer locations enabled mobile phones or other location enabled devices.

Referring to FIG. 10, sub-process 120 may be substituted for block 118 in FIG. 9 to enable a consumer to specify a home location during a commissioning procedure at which purchases can be subsequently performed. Referring also to FIG. 9, after block 116, control may pass to block 122 in FIG. 10 where a consumer indicates that the consumer is at a home location. Here, it is assumed that when the consumer indicates that the consumer is at a home location, a consumer also has the consumer's location enabled mobile phone 24 at that home location and that the mobile phone is turned on. At block 124, authorization entity 12 transmits a communication to mobile phone 24 via network operator 14 requesting the location of the mobile phone 24. At block 126, mobile phone 24 transmits its location Lₘₚ via network operator 14 to authorization entity 12. At block 128, authorization entity 12 stores the correlated credit account ID number, mobile phone information and customer home location in the consumer database 15. To this end, exemplary consumer database 15 in FIG. 2 includes a consumer home location column 44 where a separate home location Lₕₒₘₑ₁, Lₕₒₘₑ₂, etc., is listed for each one of the credit account ID numbers in column 40.

While only one home location is listed in column 44 for each one of the ID numbers in column 40, it should be appreciated that each consumer may have more than one home location. For example, a consumer may have more than a single home and may have a separate computer for remote purchases in each one of the homes. As another instance, a consumer may have a computer at home which is used for remote purchases and may also have a separate computer at work which is used for making remote purchases. In this case, locations corresponding to each of the home and work computers may be separate home locations. In these cases, two or more home locations may be listed in column 44 for each one of the ID numbers in column 40.

Referring now to FIG. 11, a sub-process 130 that may be substituted for a portion of the process shown in FIG. 6 is illustrated. The process in FIG. 11 is performed by authorization entity 12 to allow or authorize a purchase made from a home location when a consumer's mobile phone 24 is present at the home location. Referring also to FIG. 6, after block 74, control may pass to block 132 in FIG. 11 where authorization entity 12 uses the consumer database 15 to identify a home location Lₕₒₘₑₓ associated with a credit account ID number used to attempt to make a purchase. At decision block 134, where the mobile phone location Lₘₚ is the home location Lₕₒₘₑₓ, control passes to block 142 where authorization entity 12 transmits an authorization communication 34 to merchant 18. Where the mobile phone location Lₘₚ is other than the home location Lₕₒₘₑₓ, control passes to block 76 in FIG. 6. At blocks 76, 78, 80 and 82, authorization entity 12 operates in the manner described above with respect to FIG. 6 to either authorize or reject a purchase as a function of whether or not the mobile phone 24 is located at a merchant's location Lₘₑᵣₓ.

While the embodiments described above use mobile phone location with respect to a merchant's location or a home location to determine whether or not purchases should be authorized, in other embodiments when a purchase is attempted, authorization entity 12 may be programmed to simply seek direct authorization from a consumer 20 via the consumer's mobile phone 24. To this end, referring to FIG. 12, a sub-process that may be substituted for a portion of the process shown in FIG. 6 is illustrated. Referring also to FIG. 6, after block 70, control may pass to block 152 where the authorization entity 12 communicates a request to the mobile phone 24 via the network operator 14 to obtain authorization from the mobile phone user or consumer 12 for the purchase. In response to the request, the consumer 20 uses mobile phone 24 to either authorize or reject the purchase and that selection is transmitted via operator 14 to authorization entity 12. In response to the transmission, authorization entity 12 determines whether or not the purchase was authorized. Where the consumer authorized the purchase, at block 156, authorization entity 12 transmits an authorization communication 34 to merchant 18. Where the purchase is rejected, authorization entity 12 transmits a rejection communication 34 to merchant 18.

In still other embodiments it is contemplated that a mobile electronic device such as a mobile phone or the like may itself be used as a consumer transaction device to commence a purchase. For example, mobile phone 24a in FIG. 13 may include credit account identification information or the like which can be used at a merchant's place of business to purchase products or services. Here, the mobile phone 24a would wirelessly provide the credit account information to a merchant 18 upon command by the consumer 20 and the merchant would then use that information in the same fashion that the information is typically used when obtained from a credit card. Here, consistent with at least some inventive embodiments, referring to FIG. 13, a consumer apparatus 160 may be correlated or paired with the mobile phone 24a such that mobile phone 24a cannot be used to make a purchase unless apparatus 160 is located proximate (e.g., within 10 feet) the mobile phone 24a. Thus, if mobile phone 24a is lost or stolen, the mobile phone 24a would be useless for making purchases. In the illustrated embodiment, consumer apparatus 160 is shown as a device that can be clipped on a consumer's belt or the like. Other consumer apparatus are contemplated.

Referring still to FIG. 13, in at least some embodiments consumer apparatus 160 may be GPS enabled so that its location can be determined when mobile phone 24a is used to attempt to make a purchase and the location of the apparatus 160 can then be used in the manner described above to determine whether or not a purchase should be authorized.

In other embodiments, mobile phone 24a and apparatus 160 may be equipped to communicate with each other via Bluetooth protocol, some other wireless protocol, capacitive coupling through the consumer's body, etc. In these cases, for example, mobile phone 24a may be programmed to, prior to transmitting credit account information to a merchant, communicate with apparatus 160 to ascertain whether or not apparatus 160 is proximate mobile phone 24a. Where apparatus 160 is not proximate mobile phone 24a, the mobile phone 24a would either not transmit the account information to the merchant or would transmit a rejection transmission indicating that the purchase should not be completed. Where apparatus 160 is proximate mobile phone 24a, mobile phone 24a would transmit the credit account information to the merchant to complete the purchase.

Consumer apparatus 160 may be an apparatus sent by the issuer of the consumer account associated with the mobile electronic device. Consumer apparatus 160 may be sent to a consumer pre-paired for use with the consumer account. Alternatively, the consumer apparatus can be configured by the consumer for use with mobile phone 24a. Additionally, according to some embodiments, the consumer apparatus 160 may be associated with more than one mobile phone. For example, a husband and wife may associate the consumer apparatus 160 with both of their phones. Alternatively, mobile phone 24a may be associated with multiple consumer apparatuses. For example, a husband's mobile phone may be associated with a consumer apparatus 160 primarily carried by the husband and a second consumer apparatus primarily carried by the husband's wife.

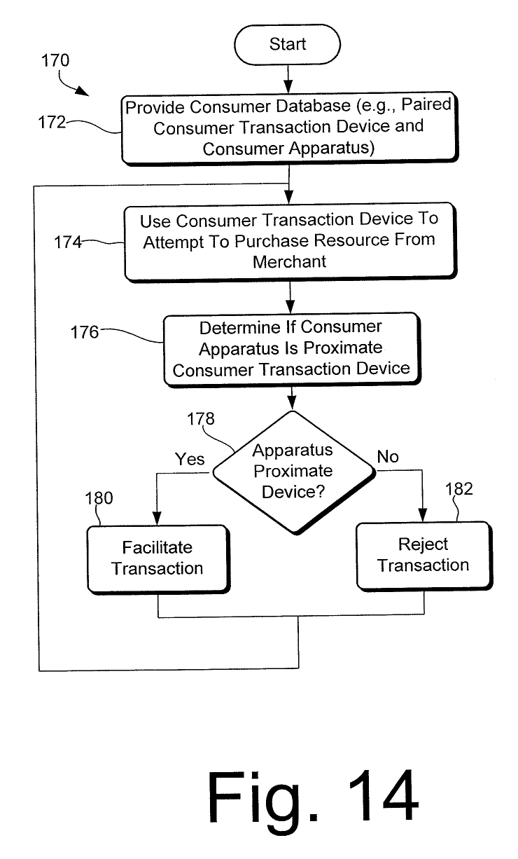

Referring now to FIG. 14, a process 170 is illustrated that is consistent with the process described above with respect to FIG. 13. At block 172, a consumer database like the database shown in FIG. 2 is provided which pairs consumer transaction devices (e.g., a transaction enabled mobile phone 24a) and consumer apparatus (e.g., 160 in FIG. 13). At block 174, the consumer transaction device 24a is used to attempt to purchase a resource from a merchant. At block 176, mobile phone 24a determines whether or not the consumer apparatus 160 is proximate mobile phone 24a. At block 178, where the apparatus 160 is proximate mobile phone 24a, the transaction is facilitated at block 180. However, if apparatus 160 is not proximate mobile phone 24a at block 178, at block 182 the transaction is rejected.

According to some embodiments, the consumer may be able to override the use of the consumer apparatus 160 by entering a password, PIN, or other authentication means into the phone. In this manner, should the consumer forget to bring the consumer apparatus 160 with him or her when conducting a transaction, the phone can still be used to conduct the transaction. Alternatively, the consumer apparatus 160 may only be used for transactions over a certain value. Other rules for determining when the consumer apparatus 160 needs to be in proximity to the mobile phone 24a can also be used according to various embodiments.

One or more specific embodiments of the present invention have been described above. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Thus, the invention is to cover all modifications, equivalents, and alternatives falling within the spirit and scope of the invention as defined by the following appended claims. For example, where two or more mobile phones are associated with a single credit account, authorization entity 12 may sequentially or simultaneously check phone locations and where any of the associated phones is in a location associated with a merchant and/or a home location, a purchase may be authorized. As another example, while described above in the context of credit accounts and an attempted purchase, the inventive methods and apparatus may be used with any type of financial account, medical/health account, etc., where an account user attempts to access or use an account for any purpose. For instance, in the case of a patient attempting to access personal health information from a home computer via the Internet, the patient's home location can be verified using a location enabled phone or other consumer apparatus prior to granting access to the patient's health account information.

The various participants and elements described above may operate or be implemented using one or more computer apparatuses to facilitate the functions described herein.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. An apparatus for identifying attempted fraud using a consumer account in real time, the apparatus comprising:
a processor;
a computer-readable medium comprising computer-executable code, the code comprising instructions to direct the processor to perform the steps of:
determining when a consumer account is used to attempt to obtain a resource from a resource provider;
determining whether a first consumer apparatus that is associated with the consumer account is located at an authorized location; and
indicating to the resource provider that the resource provider should provide the resource when the consumer apparatus is at the authorized location;
wherein the authorized location is a location proximate to a second consumer apparatus that is associated with the first consumer apparatus.

2. The apparatus of claim 1 wherein the first consumer apparatus and the second consumer apparatus communicate via wireless communication and wherein, when consumer account is used to attempt to obtain a resource, the first consumer apparatus communicates with the second consumer apparatus to determine proximity.

3. The apparatus of claim 1 wherein the first consumer apparatus communicates via one of Bluetooth communication and capacitive coupling.

4. The apparatus of claim 1 wherein the first consumer apparatus is used to provide information about the consumer account to the resource provider.

5. The apparatus of claim 1 wherein the first consumer apparatus indicates to the resource provider whether the first consumer apparatus is proximate to the second consumer apparatus.

6. An apparatus for identifying attempted fraud using a consumer account in real time, the apparatus comprising:
a processor;
a computer-readable medium comprising computer-executable code, the code comprising instructions to direct the processor to perform the steps of:
determining when a consumer account is used to attempt to obtain a resource from a resource provider;
determining whether a consumer apparatus that is associated with the consumer account is located at an authorized location; and
indicating to the resource provider that the resource provider should provide the resource when the consumer apparatus is at the authorized location;
transmitting a message to the consumer apparatus indicating that an attempt has been made to use the consumer device when the identified consumer apparatus is at a location other than the authorized location when the consumer account is used;
receiving an authorization transmission originated at the consumer apparatus authorizing the attempted use; and
transmitting a signal to the resource provider indicating that the source should be provided when an authorizing transmission that originated at the consumer apparatus is received.

7. The apparatus of claim 6 wherein the authorized location is a location associated with the resource provider.

8. The apparatus of claim 6 wherein the authorized location is a location associated with location previously registered with the authorization entity by the consumer.

9. The apparatus of claim 6 wherein the code instructing the processor to perform the step of transmitting a message addressed to the consumer apparatus further comprises code for transmitting an indication of the resource provider from which the resource has been sought and an indication of the resource sought.

10. A method for real time identification of attempted fraud involving the use of a consumer account, the method comprising:
determining when a consumer account is used to attempt to obtain a resource from a resource provider;
determining whether a first consumer apparatus that is associated with the consumer account is located at an authorized location; and
indicating to the resource provider that the resource provider should provide the resource when the consumer apparatus is at the authorized location;
wherein the authorized location is a location proximate to a second consumer apparatus that is associated with the first consumer apparatus.

11. The method of claim 10 wherein the first consumer apparatus and the second consumer apparatus communicate via wireless communication and wherein, when consumer account is used to attempt to obtain a resource, the first consumer apparatus communicates with the second consumer apparatus to determine proximity.

12. The method of claim 11 wherein the first consumer apparatus communicates via one of Bluetooth communication and capacitive coupling.

13. The method of claim 10 wherein the first consumer apparatus is used to provide information about the consumer account to the resource provider.

14. The method of claim 13 wherein the first consumer apparatus indicates to the resource provider whether the first consumer apparatus is proximate to the second consumer apparatus.

15. A computer-readable medium comprising computer-executable code for performing the steps of claim 10.

16. A method for identifying attempted fraud using a consumer account in real time, the method comprising the steps of:
determining at an authorization entity when a consumer account is used to attempt to obtain a resource from a resource provider;
determining at the authorization entity whether a consumer apparatus that is associated with the consumer account is located at an authorized location; and
indicating to the resource provider that the resource provider should provide the resource when the consumer apparatus is at the authorized location;
transmitting a message to the consumer apparatus indicating that an attempt has been made to use the consumer device when the identified consumer apparatus is at a location other than the authorized location when the consumer account is used;
receiving an authorization transmission originated at the consumer apparatus authorizing the attempted use; and
transmitting a signal to the resource provider indicating that the source should be provided when an authorizing transmission that originated at the consumer apparatus is received.

17. The method of claim 16 wherein the authorized location is a location associated with the resource provider.

18. The method of claim 16 wherein the authorized location is a location associated with location previously registered with the authorization entity by the consumer.

19. The method of claim 16 wherein the step of transmitting a message addressed to the consumer apparatus includes transmitting an indication of the resource provider from which the resource has been sought and an indication of the resource sought.

20. A computer-readable medium comprising computer-executable code for performing the steps of claim 16.
